(19) United States
(12) Patent Application Publication
(10) Pub. No.: US 2004/0267820 A1
(43) Pub. Date: Dec. 30, 2004

(54) Method and system for recording and replaying internet transactions

(75) Inventors: Jerome D. Boss, Bellevue, WA (US); Cezary Marcjan, Redmond, WA (US); Ryan R. Hamlin, Woodlinville, WA (US); Pierre P. Cote, Bellevue, WA (US)

Correspondence Address: WOODCOCK WASHBURN LLP, ONE LIBERTY PLACE - 46TH FLOOR, PHILADELPHIA, PA, 19103, US

(73) Assignee: Microsoft Corporation, Redmond, WA (US)

(21) Appl. No.: 10/895,663

(22) Filed: Jul. 21, 2004

Related U.S. Application Data
(62) Division of application No. 09/417,739, filed on Oct. 14, 1999.

(51) Int. Cl. G06F 7/00

(52) U.S. Cl. 707/104.1

(57) ABSTRACT

A system for recording and replaying Internet transactions is disclosed. The system uses a recorder object that connects between the Internet and an Internet client through the Internet client's proxy server interface. All communications between the Internet client and the Internet pass through the recorder object, and the recorder object is therefore able to observe directly the exact content of the communications, as well as other aspects of the communications, such as the rate at which they take place, the number and size of packets into which they are bundled, errors in communication, and DNS resolution time. This information can be used to produce a detailed record of the transaction, which can then be reproduced by an Internet client which is configured to use the record to replay the recorded transaction.

### TECHNICAL FIELD

This invention relates to the field of computer networks, and, more particularly, to the recording and replaying of transactions between an Internet client and the Internet.

### BACKGROUND OF THE INVENTION

An Internet transaction includes steps that a computer user performs to communicate with an Internet server to perform a task, such as reading E-mail, or purchasing airline tickets. There are various applications for which it is useful to record an Internet transaction, and to replay it in the future, for such purposes as service monitoring and performance analysis. For example, companies that use web sites to advertise and sell merchandise may wish to monitor the performance of their web sites for such factors as response time, speed of downloading, etc., in order to ensure that the web site provides customers and potential customers with a pleasurable shopping or browsing experience. Because the performance of a web site, as perceived by an Internet user, depends greatly on the location within the Internet from which the user accesses the site, it is useful to obtain an average performance by analyzing the performance of a given transaction performed at various locations. One way to gather such data is to record an Internet transaction and then to replay it on different client machines throughout the world.

Existing transaction recorder technology generally relies on an Internet client, such as a web browser, to send the recorder information about transactions performed with the client. In other words, the recorder never sees the exact communication being sent over the Internet by the client, but rather receives a report from the client as to what occurred in the transaction. This approach presents drawbacks: First, the detail and accuracy of the record created is limited by what the client communicates to the recorder; second, the recorder may be dependent on either a particular browser, a particular protocol (such as HTTP, or FTP), or both. Replaying a transaction recorded under existing technology is necessarily limited by the level of detail recorded; for example, the particular Universal Record Locators (URLs) requested by the client may be replicated, but the time between requests, which may be relevant to the purpose for which the transaction is being replayed, may not be replicated if it has not been recorded. Moreover, existing transaction replayer technology does not generally permit the user to specify certain details of the manner of replaying a transaction, such as the speed at which communications will take place.

In view of the foregoing, there is clearly a need for a system that overcomes the limitations of the prior art.

### SUMMARY OF THE INVENTION

The present invention includes a recorder object, which is coupled between an Internet client, such as a web browser, and the Internet. During the recording process, the client is configured to point at the transaction recorder as its proxy server. The recorder object relays communications between the client and the Internet substantially unaltered, while recording the content of the communication. During a connection with the Internet, the recorder object is visible to the Internet as a client requesting services, and is visible to the client as a server providing the requested services.

An analysis module may interpret the record created by the recorder object. For example, certain URL requests by the Internet client may be interpreted as the following of a hyperlink on a web page previously received by the client. When a request for a URL is recorded by the recorder object, it is compared with URLs referenced in hyperlinks on the web page that the client received immediately prior to the request. If the URL appeared in one of the hyperlinks, for example the n-th hyperlink on the page, then the URL request is interpreted as the user following the n-th hyperlink on the page rather than as a request for the particular URL, and can be replayed accordingly. Recognizing and replicating the action of following hyperlinks permits a transaction to be replayed in a manner that more accurately reflects the way that a true user would use the Internet.

The recorder object records details of the transaction, such as the duration of a communication, the time between communication events, the sizes of packets used in communications, and the DNS resolution time of a URL. This information can be used to replicate particular aspects of the transaction, such as the time between URL requests, and the speed at which information is transmitted by the client to the Internet. The transaction replayer can also regulate these quantities at the direction of an operator of the system.

The invention also contemplates the use of a transaction replayer, which interprets the record generated by the recorder and executes the recorded steps. These steps include opening and closing connections and sending requests. The steps may be replayed in real time, or slowed down to simulate a slow connection. The replayer also analyzes responses to requests, compares responses with responses received during recording of the transactions and measures the duration and size of requests and responses.

Other features of the invention are described below.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a diagram representing a computer system in which aspects of the invention may be incorporated;

FIG. 2 is a diagram of an exemplary network structure in which aspects of the invention may be incorporated;

FIG. 3 is a diagram of an exemplary structure the Internet network, in which aspects of the invention may be incorporated;

FIG. 4 shows an example display of a network client, with which aspects of the invention may be used;

FIG. 5 is a block diagram showing a proxy server coupled between a web browser and the Internet;

FIG. 6 shows a dialog box used for setting the connections of an Internet client for use with an aspect of the invention;

FIG. 7 shows a dialog box used for configuring the proxy server settings of an Internet client for use with an aspect of the invention;

FIG. 7A shows a dialog box used for configuring the listening port and proxy server parameters of an example recorder object in accordance with an aspect of the invention;

FIG. 7B shows an example connection structure, in which a recorder object is inserted into the connection between a network client and a network that have been separated by a firewall;

FIG. 8 is a block diagram showing the operation of an Internet transaction recorder in accordance with an aspect of the invention;

FIG. 9 shows a sample web page with hyperlinks for use with an aspect of the invention.

FIG. 10 is a flowchart illustrating the use of a transaction recorder in accordance with an aspect of the invention;

FIG. 11 is a block diagram showing a transaction replayer that uses the recording created by a transaction recorder;

FIG. 12 is a flowchart illustrating the use of a transaction replayer in accordance with an aspect of the invention.

### DETAILED DESCRIPTION OF THE INVENTION

Overview

The breadth of the Internet and its global reach makes it possible for computer users to engage in transactions with computers in all parts of the world. Due to the global nature of the Internet and its complexity, the quality of a connection to an Internet site often depends on where the connecting computer is located and how it is connected to the Internet. In order to evaluate the performance of a web site, it is useful to record an Internet transaction with an Internet destination and to replay the transaction on several computers connected to the Internet at diverse locations. A personal computer may be used to engage in, and record, an Internet transaction with a remote computer, and the recording may be used by another computer to replay the transaction.

Computer Environment

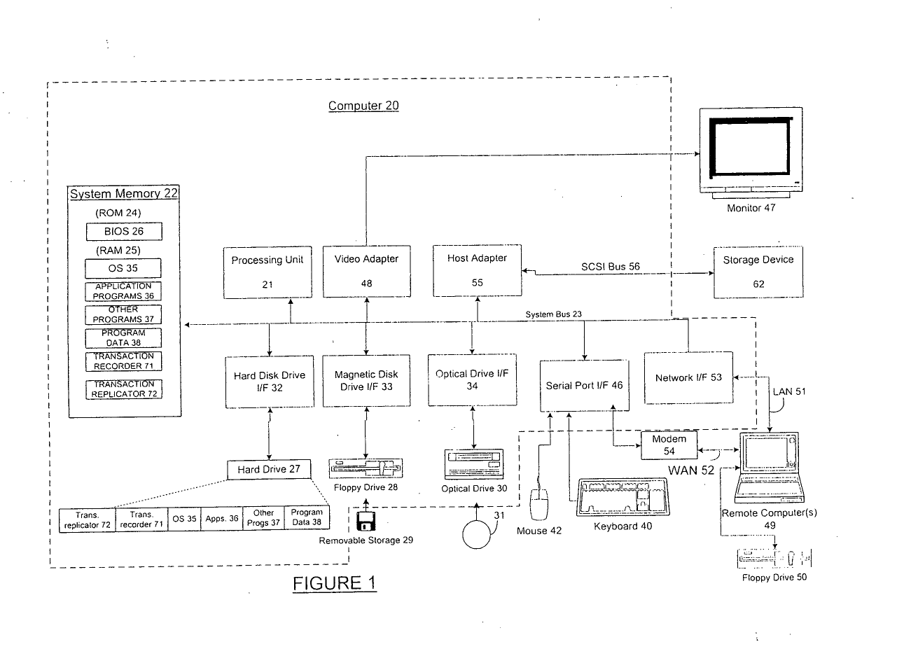

FIG. 1 and the following discussion are intended to provide a brief general description of a suitable computing environment in which the invention may be implemented. Although not required, the invention will be described in the general context of computer-executable instructions, such as program modules, being executed by a computer, such as a client workstation or a server. Generally, program modules include routines, programs, objects, components, data structures and the like that perform particular tasks or implement particular abstract data types. Moreover, those skilled in the art will appreciate that the invention may be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 1, an exemplary system for implementing the invention includes a general purpose computing device in the form of a conventional personal computer 20 or the like, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read-only memory (ROM) 24 and random access memory (RAM) 25. A basic input/output system 26 (BIOS), containing the basic routines that help to transfer information between elements within the personal computer 20, such as during start-up, is stored in ROM 24. The personal computer 20 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD-ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide non-volatile storage of computer readable instructions, data structures, program modules and other data for the personal computer 20. Although the exemplary environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, Bernoulli cartridges, random access memories (RAMs), read-only memories (ROMs) and the like may also be used in the exemplary operating environment.

A number of program modules may be stored on the hard disk, magnetic disk 29, optical disk 31, ROM 24 or RAM 25, including an operating system 35, one or more application programs 36, other program modules 37, program data 38, a transaction recorder 71, and a transaction replayer 72. A user may enter commands and information into the personal computer 20 through input devices such as a keyboard 40 and pointing device 42. Other input devices (not shown) may include a microphone, joystick, game pad, satellite disk, scanner or the like. These and other input devices are often connected to the processing unit 21 through a serial port interface 46 that is coupled to the system bus, but may be connected by other interfaces, such as a parallel port, game port, universal serial bus (USB), or a 1394 high-speed serial port. A monitor 47 or other type of display device is also connected to the system bus 23 via an interface, such as a video adapter 48. In addition to the monitor 47, personal computers typically include other peripheral output devices (not shown), such as speakers and printers.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise-wide computer networks, Intranets and the Internet.

When used in a LAN networking environment, the personal computer 20 is connected to the local network 51 through a network interface or adapter 53. When used in a WAN networking environment, the personal computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

Network Environment

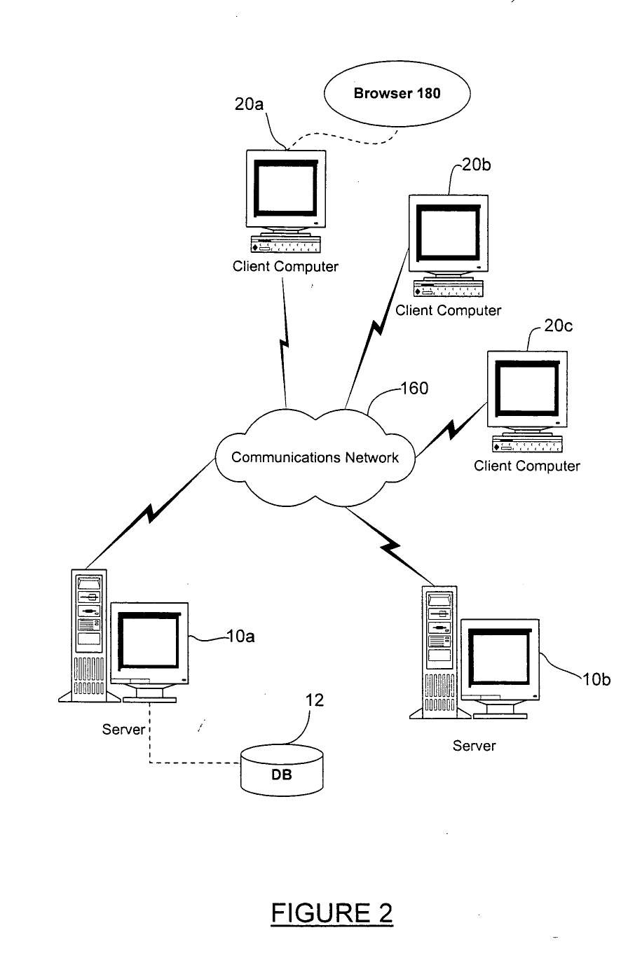

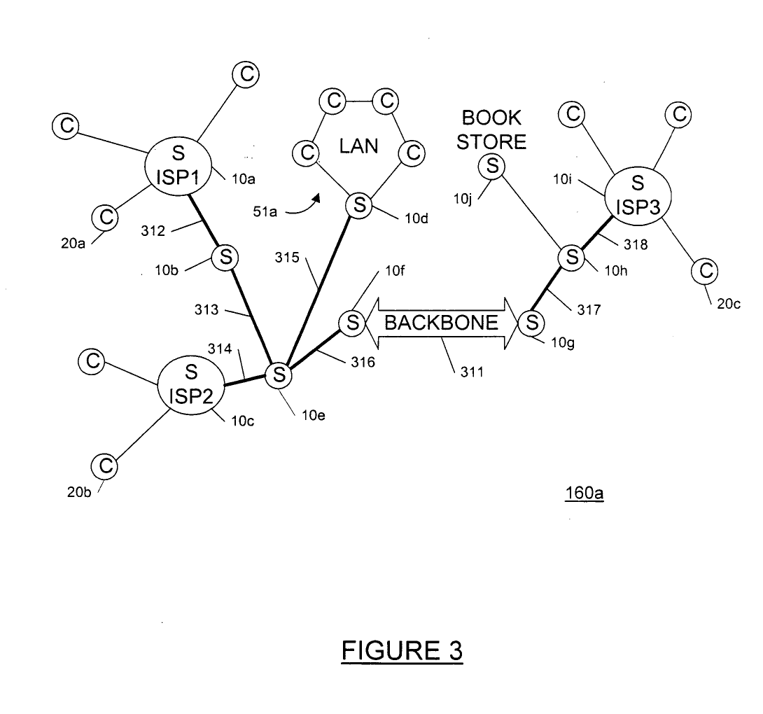

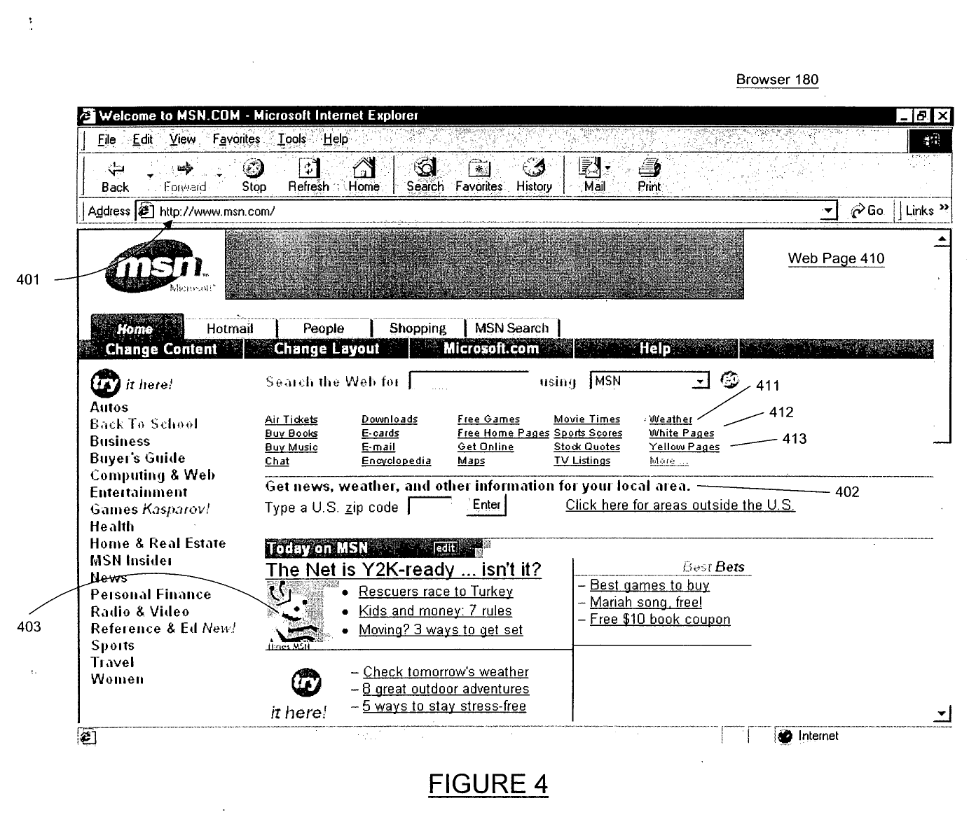

As noted, the computer described above can be deployed as part of a computer network. In general, the above description applies to both server computers and client computers deployed in a network environment. FIG. 2 illustrates one such exemplary network environment in which aspects of the present invention may be employed. As shown in FIG. 2, a number of servers 10a, 10b, etc., are interconnected via a communications network 160 (which may be a LAN, WAN, intranet-or the Internet) with a number of client computers 20a, 20b, 20c, etc. In a network environment in which the communications network 160 is the Internet, for example, the servers 10 can be Web servers with which the clients 20 communicate via any of a number of known protocols such as hypertext transfer protocol (HTTP). Each client computer 20 can be equipped with an Internet client, such as browser 180, to gain access to the servers 10. A server may be coupled to a database such as database 12 for providing information to a client.

FIG. 3 shows an exemplary structure wherein a network, such as network 160, may be implemented as part of the Internet. Internet structure 160a includes numerous servers 10a-10j (each designated with an “S”) interconnected by high-speed connections 3111-318. The high speed connections are of several different types: for example, connection 313 is a T1 connection, connection 315 is a high-speed fiber-optic connection, part of the so-called “backbone” of the Internet, and connection 318 is a lower-speed ISDN connection. Internet structure 160a also includes numerous clients (each designated with a “C”) connected to the servers. Most of the clients are connected to the Internet via an Internet Service Provider (ISP). For example, client 20a is connected to the Internet via ISP1 server 10a.

ISPs are servers on the Internet and provide Internet access to individual subscribing clients. A subscribing client typically gains access to the Internet using a modem to call the ISP. The client typically dials a local telephone phone number to establish a connection to the Internet via the ISP by connecting to the ISP's point of presence (POP). A local area network (LAN) of clients can also be connected to the Internet, either via a dial-up connection or a permanent connection. For example, LAIN 51a is connected to the Internet via one of the nodes 10d on LAIN 51a that happens to be a server.

In the example, server 10j is the server of a large bookstore that advertises and sells books over the Internet, for example by maintaining a web site. The customers of the bookstore access the Internet as clients 20a-20c. Customer clients 20a and 20c may, for example, be individuals who buy books and access the Internet from their respective homes in California and New York. The bookstore server 10j may, for example, be located in Illinois.

Internet Transaction Recorder

The transaction recorder creates a record of a transaction between a user and the Internet, where the user engages in the transaction through a web browser, such as browser 180. A user engages in an Internet transaction by using browser 180 to request a series of web pages from the Internet. FIG. 4 shows an exemplary visual interface of browser 180, as it might be displayed on a display device, such as monitor 47. A user begins the transaction by requesting a web page, such as web page 410. The visual interface of browser 180 displays web page 410 and shows the Universal Record Locator (URL) 401 of web page 410. Web page 410 displays information to the user, such as text 402 and graphics 403. Web page 410 also contains hyperlinks 411-413. A hyperlinks includes information to be displayed to the user, such as the text shown in hyperlinks 411-413, and also include the URL of a web page (not shown). By using a pointing device, such as mouse 42, a user may click on a hyperlink, which instructs browser 180 to retrieve from the Internet the web page referenced by the URL in the hyperlink and to display that web page to the user. For example, a user may follow hyperlink 412 by using mouse 42 to click on the text “White Pages” in hyperlink 412, thereby causing browser 180 to retrieve and display the web page referenced by the URL in hyperlink 412. The referenced web page could contain, for example, a directory of telephone numbers and E-mail addresses of people living in the user's geographic region, along with additional hyperlinks. In a typical session with browser 180, a user begins the transaction by requesting a web page. The user may then pause for a moment to read the information on the web page, and then follow a hyperlink on the web page. Retrieval of the web page referenced in the hyperlink may arrive as quickly as permitted by the connection between browser 180 and the Internet; alternatively it may be delayed or received in pieces by web browser 180, due to a high volume of traffic on the Internet. The final request for a web page or following of a hyperlink marks the end of the transaction. As described more fully below, a transaction recorder creates a record of the series of requests, pauses, and connection delays that take place between the beginning and end of the transaction.

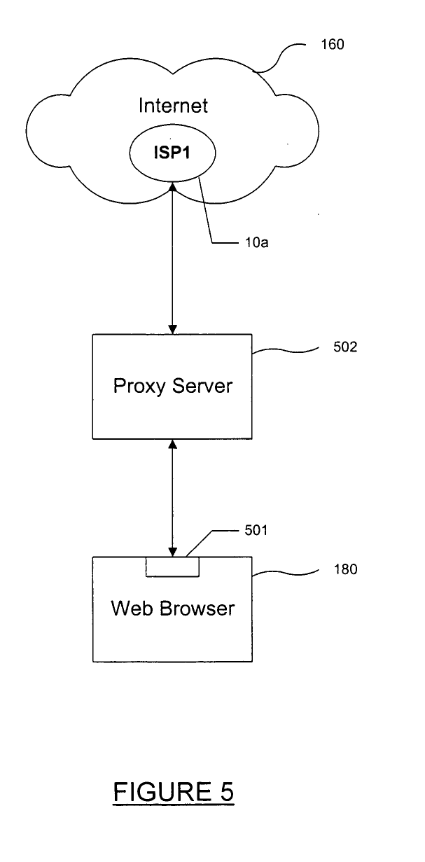

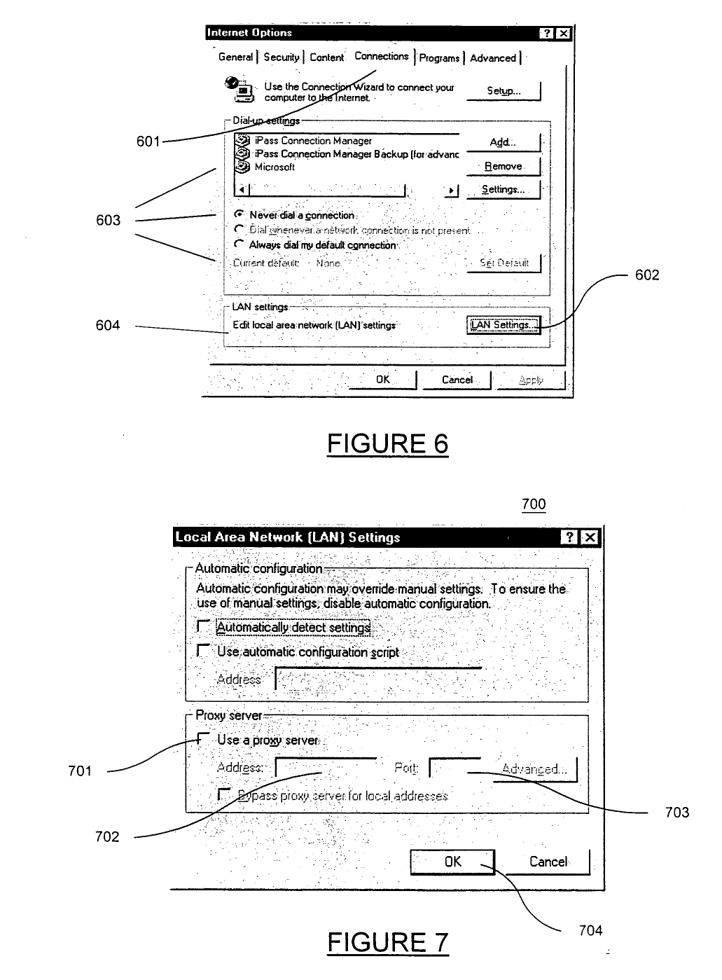

A transaction recorder in accordance with the present inventions is like a proxy server that serves as a bridge between web browser 180 and the Internet, relaying communications between the browser and the Internet while recording the communications. FIG. 5 shows a proxy server 502 in use with web browser 180. Proxy server 502 may be a dedicated machine serving as a firewall or an ISP, or it may be a transaction recorder running on the same computer 20 as web browser 180. Web browser 180 is configured to direct all outgoing communications destined for the Internet 160a, such as requests for web pages, to proxy server 502 through its proxy server interface 501. Web browser 180 is also configured to receive all incoming communications, such as retrieved web pages, from proxy server 502 through proxy server interface 501. When web browser 180 opens a connection to proxy server 502, the proxy server opens a corresponding connection to server 10a, which is part of the Internet 160a. When web browser 180 sends a request for a web page to proxy server 502, the proxy server forwards the request to the Internet 160a via server 10a. When web browser 180 closes the connection to proxy server 502, the proxy server closes the corresponding connection to server 10a.

In order to permit a user to configure web browser 180 for use with a proxy server, such as the disclosed recorder, web browser 180 provides a series of dialog boxes through which a user may instruct web browser 180 to use a proxy server and may provide information identifying the location of the proxy server. Web browser 180 has an Internet options dialog box 600, whereby a user may configure various aspects of web browser 180. A user configures web browser 180 through dialog box 600 by using an input device, such as keyboard 40 or mouse 42. One section of dialog box 600 is a connections section, which the user can view by using mouse 42 to click on tab 601 in the example shown. The connections section permits the user to configure various features of web browser 180 pertaining to the connection between web browser 180 and the Internet, such as the dial-up settings 603, and local area network settings 604. The connections section includes a button 602 marked; by using mouse 42 to click on button 602, the user is able to configure the local area network settings of web browser 180, including the proxy server settings.

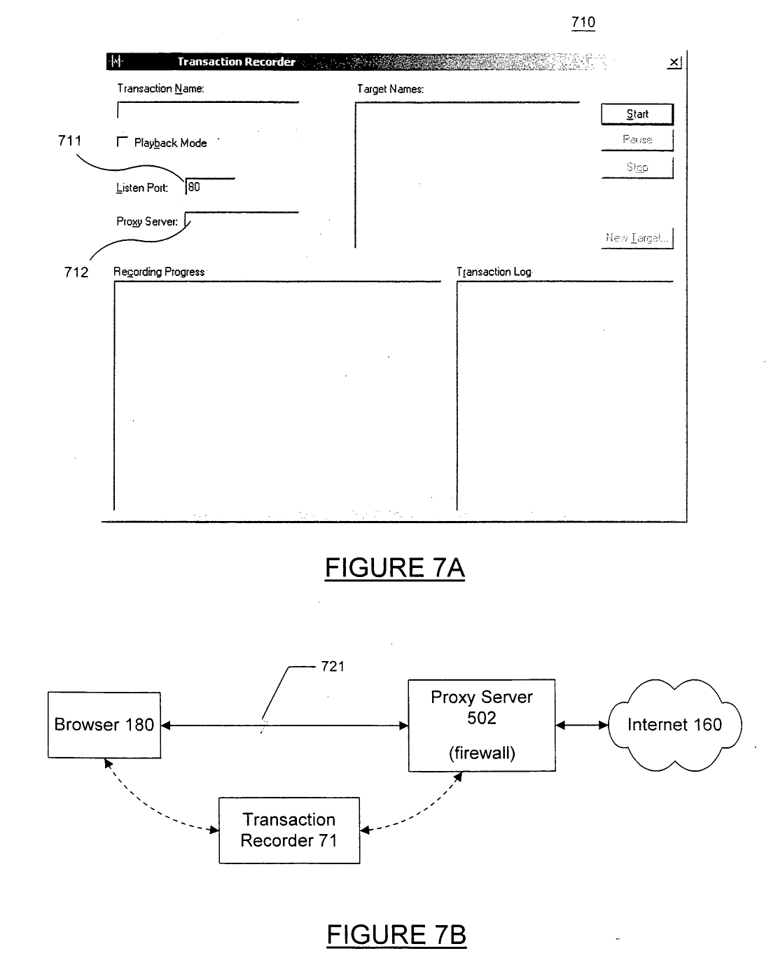

FIG. 7 shows the dialog box 700 that is displayed to the user after the user clicks on button 602. Dialog box 700 includes a check box 701; by using mouse 42 to click on check box 701, the user can configure web browser 180 to use a proxy server. The user also uses keyboard 40 to enter the address and port of the proxy server into boxes 702 and 703, respectively. An example address could be either the name of the computer (e.g. “TheProxyServer”) or an IP address (e.g. 123.123.123.123). Ports are 16 bit numbers; the HTTP protocol typically uses port 80. If a recorder object running on the same computer 20 as browser 110 is to be used as the proxy server for browser 180, the address and port of the proxy server could be set to “127.0.0.1:80” (“127.0.0.1” is the address of the local machine, and “80” is the port). After entering the information, the user clicks button 704 to complete the process of configuring web browser 180 to use a proxy server.

Alternatively, if browser 180 is able to read the Internet settings from a file, then the recorder object may configure web browser 180 without operator intervention by changing the settings contained in the file. In the case of the MICROSOFT WINDOWS operating system (e.g., WINDOWS 95/98/NT), the Internet browser (e.g., MICROSOFT INTERNET EXPLORER) could store its settings in the registry. The recorder object could write the address of a network card used to access the recorder object directly in the registry using the registry Application Programming Interfaces (APIs) provided by the MICROSOFT WINDOWS operating system. For example, where browser 180 is an instance of the MICROSOFT INTERNET EXPLORER browser running on the same machine as the recorder object in a MICROSOFT WINDOWS operating system environment, the recorder object could change the registry setting “SOFTWARE/Microsoft/Windows/CurrentVersion/InternetSettings/ProxyServer” to “localhost:80” or “127.0.0.1:80.” Prior to making the change, the recorder object would save the original setting so that it can be restored to the registry when the recorder object terminates operation.

The recorder object may also be configurable to work together with a browser 180 that has been configured to use the recorder object as its proxy sever. As depicted in FIG. 7A, an example recorder object in accordance with the invention may be a software application having a dialog box 710, in which the operator of the recorder object may configure the recorder object's parameters. Dialog box 710 includes a space 711 in which the operator may set the “listening port”—that is, the port on which the recorder can expect to receive communication from browser 180. In the preceding example, the proxy server of browser 180 has been set to “localhost:80”; in FIG. 7A, the operator of an example recorder object has set the listening port to “80,” which corresponds to the port of the proxy server setting in the preceding example.

Dialog box 710 also includes a second space 712, in which the operator may designate a proxy server for the recorder object to use for communication with a network, such as the Internet. The computer 20 on which browser 180 and the recorder object are running may be behind a firewall (i.e., on an Intranet), and the proxy server settings of browser 180 may have been set (prior to invoking the recorder object) to point to a server machine that implements the firewall. For example, where the recorder object has saved the proxy server settings from the MICROSOFT WINDOWS operating system registry, the saved settings may point to a firewall server machine. The recorder object can then be configured to use the server machine as its proxy server, for example by an operator's entering the address of the server machine in space 712; alternatively, the recorder object may be able to set the proxy server parameter without operator intervention if it knows the address of the server machine (e.g., if it has retrieved the address from the registry). FIG. 7B shows an example connection structure incorporating a recorder object 71. Browser 180 was orginally configured to access the Internet 160, using firewall server 502 as its proxy server. After the parameter changes described above in the text accompanying FIGS. 7 and 7A have been made, browser 180 points to recorder object 71 as its proxy server, and recorder object 71, in turn, points to firewall server 502 as its proxy server. Thus communications are able to pass from browser 180, to recorder object 71, to proxy server 502, to the Internet 160.

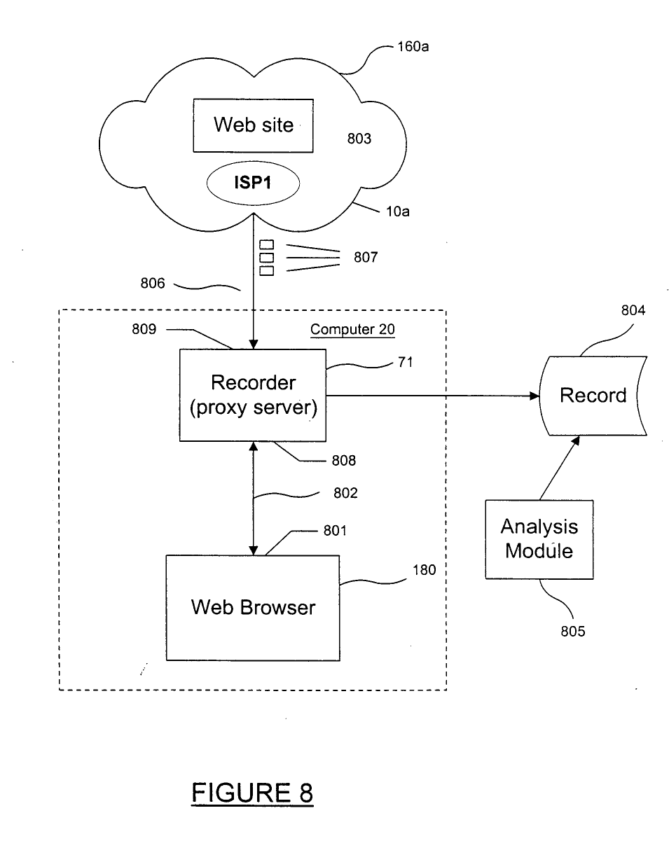

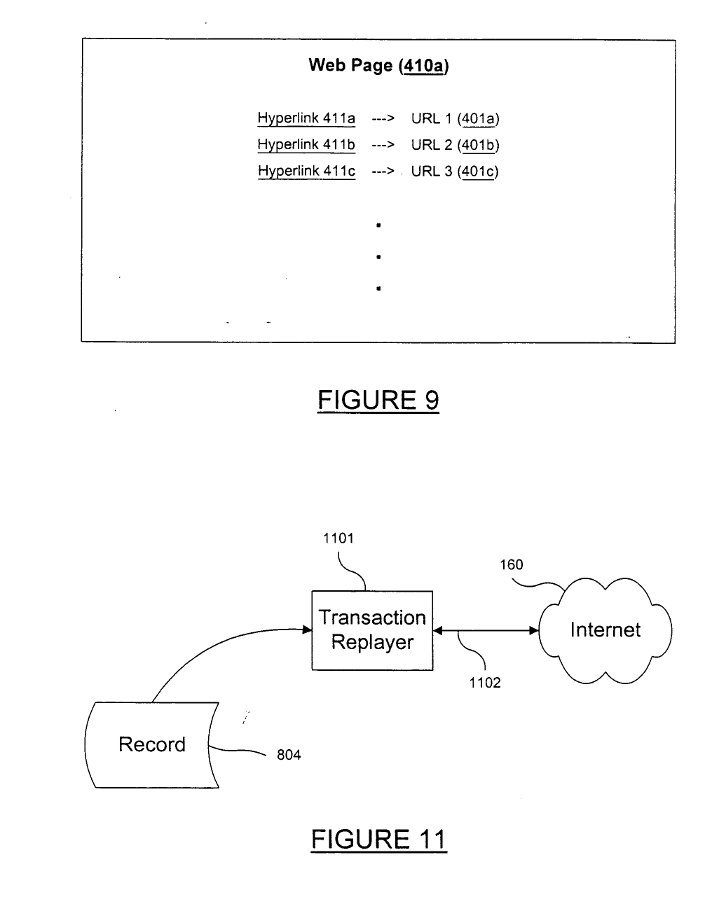

FIG. 8 shows the use of a recorder object coupled to a browser by way of a proxy server interface in accordance with the present invention. Recorder object 71 is preferably a process running on the same computer 20 as web browser 180. Recorder object 71 is coupled between web browser 180 and Internet server 10a and acts as a proxy server for browser 180. Recorder object 71 has a client interface 808, and browser 180 has a proxy server interface 801. The client interface 808 of recorder object 71 makes a connection 802 to the proxy server interface of browser 180. Connection 802 may comprise any form of interprocess communication that permits two application processes to communicate information to each other. Alternatively, if recorder object 71 is running on a different computer from web browser 180, then connection 802 may comprise the connections depicted in FIG. 3, such as an Ethernet connection, T1 connection 313, fiber-optic connection 315, or ISDN connection 318. Recorder object 71 also has an Internet interface 809, through which recorder object 71 connects to Internet server 10a through connection 806. Connection 806 comprises connections such as those depicted in FIG. 3, such as connections 313, 315, and 318.

Browser 180 sends a communication destined for the Internet 160a, such as a request for a web page located at web site 803, to recorder object 71 over connection 802 through proxy server interface 801. Recorder object 71 receives the communication through client interface 808. Recorder object 71 relays the communication to the Internet 160a over connection 806 through Internet interface 809. While relaying the communication from web browser 180 to the Internet, recorder object 71 creates a record 804 of the communication. The record includes the URL of the web page requested by browser 180, and may also include additional information such as: the duration of a communication, the sizes of packets 707 used in communications, the DNS resolution time of the URL, and the time between various communication events. As described more fully below, this information may be used in a transaction replayer to replicate some aspects of the transaction.

Recorder object 71 also receives communications from the Internet 160a destined for browser 180, such as the content of a web page requested. Recorder object 71 relays these communications to browser 160a, and may, optionally, record information about these communications, such as the content of the communication, the duration of the communication, and the time since the most recent communication from client 401 to the Internet.

One purpose of recorder object 71 is to observe and record an Internet transaction as it would otherwise have taken place in the absence of recorder object 71. To avoid affecting the transaction, recorder object 71, to the extent possible, does not interfere with communication between web browser 180 and to an Internet destination, such as web site 803, and, therefore, relays communications between web browser 71 and the Internet 160a without any substantial modification to their contents. Preferably, recorder object 71 relays communications without any content modification.

Recorder object 71 may also be associated with an analysis module 805, which is a software module that may be a component of recorder object 71. Analysis module 805 interprets communications between browser 401 and the Internet, and may modify the record to reflect its interpretation. One function of analysis module 805 is to draw inferences about the context of some communications from web browser 180, in order to permit a transaction replayer (not shown) to simulate a user transaction more accurately. For example, one communication from browser 180 may be a request to retrieve a web page 410a located at a specified URL; web page 800 is depicted in FIG. 8. Web page 410a may contain hyperlinks 411a-411c to other web pages identified by their URLs 401a-401c. The user operating browser 180 may issue a command to follow one of the hyperlinks, such as hyperlink 411b; this command will be observed and recorded by recorder object 501 only as a request for a the web page located at URL 401b. Analysis module 805 compares the URL 401b with the URLs referenced in the hyperlinks 411a-411c in web page 410a. Because URL 401b appears among hyperlinks 411a-411c, analysis module 805 concludes that browser 180 requested the web page at URL 401b as a result of following hyperlink 411b on web page 410a. This information can be entered in the record by recording the request for the web page at URL 401b as the following of the second hyperlink on web page 410a; alternatively, the record may initially contain the URL referenced in the followed hyperlink and can be modified later by analysis module 805 to reflect the following of the second hyperlink on web page 410a. The position of a hyperlink among all hyperlinks on a web page is defined as the hyperlink's ordinal position; for example, in web page 410a, the ordinal position of hyperlink 411a is first, of 411b is second, etc. Recording the request for a web page as the following of a hyperlink permits a transaction replayer making use of the record to simulate more accurately a user Internet session, in which a user follows hyperlinks on web pages rather than merely requesting a series of unrelated web pages.

Example Use of Transaction Recorder

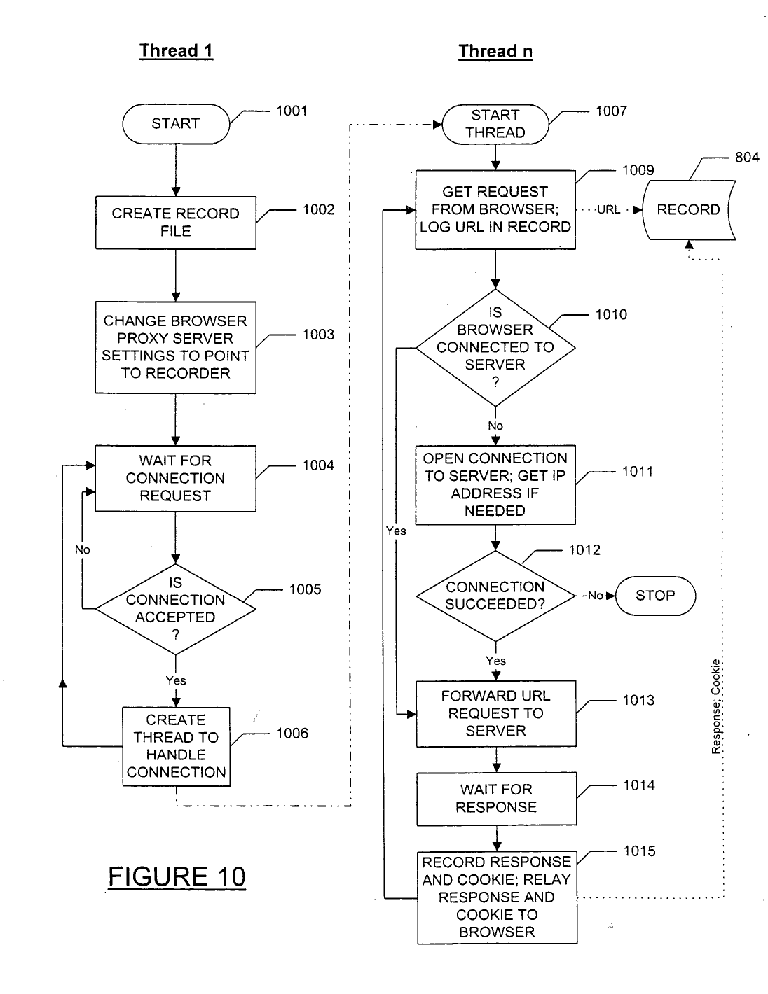

FIG. 10 is a flowchart showing the steps by which recorder object 71 operates in accordance with the present invention. Recorder object 71 starts at step 1001, running along a first execution thread, labeled “Thread 1” in FIG. 10. At step 1002, the recorder object creates a file in which to store the record of recorded transactions. At step 1003, the settings of browser 180 are set to point to recorder object 71 as a proxy server for browser 180, which configures browser 180 to communicate with recorder object 71 as its proxy server. At step 1004, the recorder object waits for browser 180 to request a connection to the Internet. After a connection is requested, the connection is either accepted or rejected at step 1005. If the connection is rejected, the flow returns to step 1004, where recorder object 71 waits for another connection request. If the connection is accepted at step 1005, a new thread, labeled “Thread n” in FIG. 10, is created at step 1006 to record the connection. “Thread 1,” which runs asynchronously with respect to “Thread n,” returns to step 1004 to wait for another connection request. Step 1006 creates a separate instance of “Thread n” for each Internet connection successfully made at step 1005, so that recorder object 71 can use a separate thread to monitor each connection.

An instance of “Thread n” begins executing at step 1007. At step 1009, recorder object 1001 receives from browser 180 a request for a web page located at a specific URL. Also at step 1009, recorder object 71 logs the request for the URL into the record 804. It is determined at step 1010 whether a connection needs to be made to an Internet server. If a connection is open, the flow proceeds to step 1013, otherwise, a connection is opened at step 1011, and the IP address of the server to which to connect is also retrieved if not already given. At step 1012, the connection either succeeds, in which case the flow proceeds to step 1013, or fails, in which case execution of “Thread n” stops. At step 1013, recorder object 71 forwards the URL request received at step 1009 to an Internet server. At step 1014, recorder object 71 waits for the response, which, for example, is the web page located at the specified URL. At step 1015, recorder object 71 records the response and any cookie into the record 804, and relays the response and cookie to browser 180. The flow then returns to step 1009 to receive the next URL request from browser 180.

Transaction Replayer

In accordance with an aspect of the invention, the record created by the recorder object 71 is created so that the recorded transaction can be replayed. A transaction replayer is a specially configured Internet client which uses the record created by recorder object 71 to generate communications to be sent over the Internet, thus simulating the recorded session.

FIG. 11 depicts the use of a transaction replayer. Transaction replayer 1101 is an Internet client connected to the Internet 160a through connection 1102. Transaction replayer makes use of the record 804 created by the process depicted in FIG. 10, to replay a recorded transaction. For example, record 804 contains URLs requested during a browser session; transaction replayer 1101 can issue requests for those same URLs. Where analysis module 805 has been used to infer which URL requests were made as the result of a user following hyperlinks, and the ordinal position of the followed hyperlink has been recorded, transaction player 1101 can carry out an instruction to follow the n-th hyperlink by examining the previous web page received, determining the URL referenced by the n-th hyperlink, and requesting the web page located at that URL, where “n-th” denotes the ordinal position of the hyperlink to be followed.

Additionally, when recorder object 71 records additional detail about the transaction, such as the duration of the communication, the sizes of packets 807 used in communications, the DNS resolution time of the URL, and the time between communication events, transaction replayer 1101 may use this information to replicate other aspects of the transaction, such as the time between URL requests, delays in transmission, the particular packet structure of the original recorded communication, etc. Additionally, transaction replayer 1101 may be configured to simulate a connection that is slower than connection 1102, by regulating the rate at which it sends communications over connection 1102. The speed-regulated communication a slow connection over which recorder object 71 recorded the original transaction; or, the speed of the communication can be regulated at the request of an operator of the transaction replayer 1101, without regard to the speed at which the transaction was recorded.

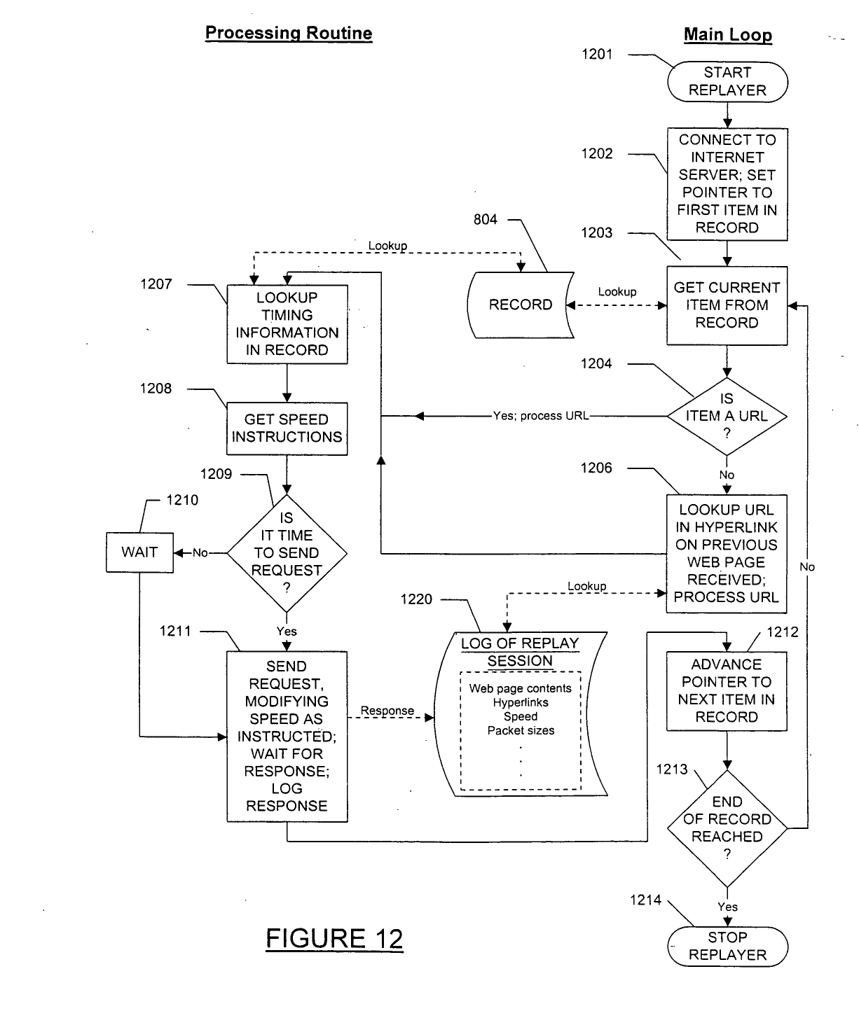

FIG. 12 is a flowchart showing the processes by which the replayer simulates a user transaction by using the record 804 created by the transaction recorder. The replayer begins its main loop by starting at step 1201. At step 1202, the replayer makes a connection to an Internet server and initializes a pointer to point to the first item in record 804. The items in record 804 include URLs of web pages to be requested, and instructions to follow hyperlinks on prior web pages. At step 1203, the replayer gets an item from record 804 by looking up the item that is currently being addressed by the pointer; at the start of the replayer session, the pointer addresses the first item. At step 1204, the replayer evaluates whether the item is a request for a specific URL. If the item is a request for a specific URL, then the replayer proceeds directly to step 1207 to process the URL; if the item is an instruction to follow a hyperlink rather than a specific URL, then the replayer looks up the hyperlink on the most recent web page, which is stored in the log 1220 of the replayer session. Log 1220, which is created during the replayer session and contains historical information about the session, is discussed below. After determining the URL referenced in the hyperlink to be followed, the replayer proceeds to the processing routine, which begins at step 1207.

The processing routine first receives two time parameters to be used in transmitting the URL request. First, at step 1207, the routine looks in record 804 for timing information that was recorded by recorder object 71, such as the time between the prior URL request and the current one. This timing information is used to simulate the pace at which a user would request a sequence of web pages, as a user typically requests a web page, pauses to read the page, and then requests the next page some time later. Second, at step 1208, the replayer receives instructions as to the speed at which the request is to be transmitted. For example, if the replayer is connected to the Internet via a fast T1 connection, it can simulate a slow dial-up connection by transmitting the request at a typical dial-up line speed, such as 14 or 28 kilobits per second. The speed instructions may come from various sources, such as a user operating the replayer or from record 804. After receiving these time parameters, the replayer determines at step 1209 whether it is time to send the request, based on the information received at step 1207. If it is time to send the request, the replayer proceeds to step 1211 to send the request to an Internet server; if it is not time to send the request, the replayer proceeds to step 1210 to wait until it is time to send the request, and then proceeds to step 1211 to send the request. At step 1211, the replayer sends the request to an Internet server, modifying the speed at which it sends the request as instructed in step 1208, and waits for a response. At step 1211, the replayer also enters into log 1220 the URL requested and information about the response, such as the contents of the web page received, hyperlinks on the received web page, speed at which the response was received, and the packet sizes of the response. Other information in log 1220 includes: DNS resolution times; connection times; time between a request and the beginning of a response; total time for each response; total transaction time; time between two specified points in the transaction; the header size of each response; the data size of each response; the total amount of data in each response; volume of data received between two specified points in a transaction; DNS resolution errors, TCP errors; protocol specific errors; and invalid response content errors.

After logging information at step 1220, the flow returns from the processing routine to the main loop at step 1212. At step 1213, the record pointer is advanced to the next item. A determination is made at step 1213 as to whether the end of the record has been reached. If the end of the record has been reached, the replayer session terminates at step 1214. Otherwise, the replayer returns to step 1203 to retrieve and process the next item in the record.

It is noted that the foregoing examples have been provided merely for the purpose of explanation and are in no way to be construed as limiting of the present invention. While the invention has been described with reference to preferred embodiments, it is understood that the words which have been used herein are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art having the benefit of the teachings of this specification, may effect numerous modifications thereto and changes may be made without departing from the scope and spirit of the invention in its aspects.

1-20. (cancelled)

21. A method of simulating a user network transaction comprising the acts of:
connecting to a network server;
retrieving a transaction item from a record of a network transaction, wherein said record was created from a prior recorded transaction; and
sending a request to said network server, wherein the content of said request is based on said transaction item.

22. The method of claim 21, wherein said network comprises the Internet.

23. The method of claim 22, wherein said transaction item comprises a representation of a Universal Record Locator of a web page to be retrieved from the Internet.

24. The method of claim 21, further comprising the act of receiving, from said network, a response to said request.

25. The method of claim 24, further comprising the act of recording said response.

26. The method of claim 24, further comprising the acts of:
retrieving a second transaction item from said record, wherein said second transaction item comprises a reference to said response; and
sending a second request to said network server, wherein the content of said request is based on data contained in said response.

27. The method of claim 26, wherein said network comprises the Internet, wherein said response comprises a web page, and wherein said data comprises a Universal Record Locator referenced in a hyperlink on said web page.

28. The method of claim 24, further comprising the acts of:
inserting a time delay following the receipt of said response;
retrieving a second transaction item from said record; and
sending a second request to a network server, wherein the content of said second request is based on said second transaction item.

29. The method of claim 21, wherein said sending act is performed at a rate slower than the rate supported by the connection to said network server.

30. The method of claim 29, wherein the rate is slowed by inserting a time delay between packets used to transmit said request.

31. A computer-readable medium containing computer-executable instructions to perform the method of claim 21.

32. A method of simulating a user network transaction comprising the acts of:
connecting to a network server;
receiving a transaction item representing a communication to be sent over a network; and
sending a request to said network server at a rate slower than the rate supported by the connection to said network server, wherein the content of said request is based on said transaction item.

33. The method of claim 32, wherein said network comprises the Internet.

34. The method of claim 32, further comprising the act of receiving, from said network, a response to said request.

35. The method of claim 34, further comprising the acts of:
inserting a time delay following the receipt of said response;
retrieving a second transaction item from said record; and
sending a second request to a network server, wherein the content of said second request is based on said second transaction item.

36. A computer-readable medium containing computer-executable instructions to perform the method of claim 32.
